(19) United States
(12) Patent Application Publication
(10) Pub. No.: US 2011/0294941 A1
(43) Pub. Date: Dec. 1, 2011

(54) VINYL CHLORIDE-BASED RESIN COMPOSITION, METHOD OF PRODUCING VINYL CHLORIDE-BASED POLYMER COMPOSITION, AND VINYL CHLORIDE-BASED POLYMER COMPOSITION OBTAINED THEREBY

(75) Inventors: Tatsuya FUJIMOTO, Kamisu-shi (JP); Tadashi Amano, Kamisu-shi (JP); Manabu Furudate, Kamisu-shi (JP); Tomohiro Inoue, Kamisu-shi (JP); Shinji Fujimoto, Kamisu-shi (JP); Ken Yahata, Kamisu-shi (JP)

(73) Assignee: Shin-Etsu Chemical Co., Ltd., Chiyoda-ku (JP)

(21) Appl. No.: 13/115,369

(22) Filed: May 25, 2011

(30) Foreign Application Priority Data
May 26, 2010 (JP) 2010-120353
May 26, 2010 (JP) 2010-120354

(51) Int. Cl. C08K 3/22; B82Y 30/00

(52) U.S. Cl. 524/497; 524/847; 977/773

(57) ABSTRACT

Provided is a vinyl chloride-based resin composition including a vinyl chloride-based resin and a titanium dioxide having an average particle diameter of 5 to 50 nm, in an amount of 1,000 ppm to 10,000 ppm, by mass, relative to the mass of the vinyl chloride-based resin. By adding a titanium dioxide having an average particle diameter of 5 to 50 nm to a vinyl chloride-based resin in an amount described above, a vinyl chloride-based resin composition of excellent thermal stability can be obtained. In the vinyl chloride-based resin composition, the crystalline form of the titanium dioxide is preferably anatase, rutile, or a combination thereof. Also provided is a method of producing a vinyl chloride-based polymer composition that includes subjecting a vinyl chloride monomer, or a mixture of a vinyl chloride monomer and a monomer that is copolymerizable therewith, to suspension polymerization within an aqueous medium, and also includes adding a titanium dioxide having an average particle diameter of 5 to 50 nm to the raw material prior to commencement of the polymerization, to the reaction mixture during the polymerization, to the reaction product following completion of the polymerization, or to a combination of two or more of the raw material, the reaction mixture and the reaction product. The vinyl chloride-based polymer composition obtained using this method exhibits excellent thermal stability.

### BACKGROUND OF THE INVENTION

1. Field of the Invention

The present invention relates to a vinyl chloride-based resin composition, and relates particularly to a vinyl chloride-based resin composition that exhibits superior productivity and excellent thermal stability. Further, the present invention also relates to a method of producing a vinyl chloride-based polymer composition and a vinyl chloride-based polymer composition obtained by the method, and relates particularly to a method of producing a vinyl chloride-based polymer composition having excellent thermal stability at a high level of productivity, and a vinyl chloride-based polymer composition obtained by the method.

2. Description of the Prior Art

Conventional vinyl chloride-based resin products are cheap, exhibit excellent levels of mechanical properties, chemical resistance, weather resistance and transparency and the like, and can be used to obtain products of any desired hardness from soft products through to hard products via the addition of various plasticizers, and are therefore used across a wide range of fields.

However, because these conventional vinyl chloride-based resins tend to exhibit poor thermal stability during molding processing, the resulting molded products often suffer from inferior mechanical properties, and coloration can also be a problem. In order to prevent these problems, methods that involve the addition of a stabilizer composed of any of a variety of metal compounds are common, and methods that involve the addition of a Ca—Zn-based stabilizer prior to processing, which satisfies the demands for a non-toxic, odorless, colorless and low-cost stabilizer, are particularly desirable. However, Ca—Zn-based stabilizers yield inferior thermal stability compared with zinc-based stabilizers and tin-based stabilizers. As a result, methods that involve increasing the amount of added stabilizer, or adding an inorganic compound-based stabilization assistant such as hydrotalcite (see Patent Document 1) have been proposed, but obtaining a satisfactory level of thermal stability has still remained elusive.
[Patent Document 1] JP 05-179090 A

### SUMMARY OF THE INVENTION

The present invention has been developed to address the problems outlined above, and has an object of providing a vinyl chloride-based resin composition having excellent thermal stability, a method of producing a vinyl chloride-based polymer composition having excellent thermal stability, and a vinyl chloride-based polymer composition obtained by the method.

As a result of intensive investigation, the inventors of the present invention discovered that by adding a predetermined amount of a titanium dioxide having an average particle diameter of 5 to 50 nm to a vinyl chloride-based resin, a vinyl chloride-based resin composition having excellent thermal stability could be obtained, and also discovered that the production method described below that uses a titanium dioxide having a predetermined average particle diameter yielded a vinyl chloride-based polymer composition having particularly superior thermal stability, and the inventors were therefore able to complete the present invention.

In other words, a first aspect of the present invention provides a vinyl chloride-based resin composition comprising:

a vinyl chloride-based resin, and

a titanium dioxide having an average particle diameter of 5 to 50 nm, in an amount of 1,000 ppm to 10,000 ppm, by mass, relative to the mass of the vinyl chloride-based resin.

A second aspect of the present invention provides a method of producing a vinyl chloride-based polymer composition, the method comprising:

subjecting a vinyl chloride monomer, or a mixture of a vinyl chloride monomer and a monomer that is copolymerizable therewith, to suspension polymerization within an aqueous medium, and also comprising:

adding a titanium dioxide having an average particle diameter of 5 to 50 nm to the raw material prior to commencement of the polymerization, to the reaction mixture during the polymerization, to the reaction product following completion of the polymerization, or to a combination of two or more of the raw material, the reaction mixture and the reaction product.

In the following description, the expression “a vinyl chloride monomer, or a mixture of a vinyl chloride monomer and a monomer that is copolymerizable therewith” may be abbreviated using the generic expression “vinyl chloride-based monomer”.

A third aspect of the present invention provides a vinyl chloride-based polymer composition obtained using the method described above.

By adding a titanium dioxide having an average particle diameter of 5 to 50 nm to a vinyl chloride-based resin in an amount equivalent to 1,000 ppm to 10,000 ppm, by mass, relative to the mass of the vinyl chloride-based resin, a vinyl chloride-based resin composition having excellent thermal stability can be obtained. Further, by employing the production method of the present invention that uses a titanium dioxide having an average particle diameter of 5 to 50 nm, a vinyl chloride-based polymer composition having excellent thermal stability can be produced. Titanium dioxide is widely used as a white pigment or ultraviolet absorption material within the raw materials of paints and cosmetics and the like, and because it is an extremely safe material that is even permitted as a food additive, the vinyl chloride-based resin composition of improved thermal stability according to the present invention and the vinyl chloride-based polymer composition of improved thermal stability according to the present invention can be used across an even wider range of fields than conventional vinyl chloride-based resin compositions and polymer compositions.

### DETAILED DESCRIPTION OF THE PREFERRED EMBODIMENTS

A more detailed description of the present invention is provided below.

### 1. Vinyl Chloride-based Resin Composition

### [Titanium Dioxide]

The titanium dioxide used in the vinyl chloride-based resin composition of the present invention has an average particle diameter that is typically within a range from 5 to 50 nm, and preferably from 5 to 25 nm. If the average particle diameter is less than 5 nm, then the surface energy increases, increasing the likelihood of aggregation. In contrast, if the average particle diameter exceeds 50 nm, then the thermal stability effect provided by the titanium dioxide may deteriorate. In this specification, the term “average particle diameter” refers to the volume-referenced particle diameter corresponding with a value of 50% in the cumulative distribution (hereinafter also referred to as “D₅₀”), and is measured by a dynamic scattering method using a laser light.

Titanium dioxide has three crystalline forms, known as anatase, rutile and brookite. Of these, the rutile and anatase forms are used industrially, whereas the brookite form is presented merely from an academic perspective, and is not currently used in industry. The crystalline form of the titanium dioxide used in the vinyl chloride-based resin composition of the present invention is preferably the anatase form, the rutile form, or a combination thereof.

In the vinyl chloride-based resin composition of the present invention, the titanium dioxide can be used in the form of a dispersion or a powder or the like, and the use of a dispersion is preferred. In this dispersion, microparticles of the titanium dioxide are preferably dispersed as finely as possible within the dispersion medium. Examples of the dispersion medium include aqueous media. Examples of such aqueous media include water, and mixed solvents containing water and a hydrophilic organic solvent which is mixed with the water in an arbitrary ratio. The hydrophilic organic solvent is preferably an alcohol such as methanol, ethanol or isopropanol. The aqueous medium is preferably water, and is most preferably a deionized water, distilled water or purified water.

The concentration of the titanium dioxide within the above-mentioned dispersion is preferably within a range from 0.01 to 20% by mass, and is more preferably from 1 to 5% by mass. The pH of the dispersion is preferably not within the vicinity of the isoelectric point of the titanium dioxide (anatase: 5.1, rutile: 5.6), and is more preferably either within a range from pH=1 to 4, or within a range from pH=7 to 14.

The titanium dioxide dispersion can be obtained by conventional methods. For example, an anatase type titanium dioxide dispersion can be obtained in the manner described below. First, an aqueous solution of titanium chloride is gradually neutralized and hydrolyzed using ammonia to obtain titanium hydroxide. Following a deionization treatment of this titanium hydroxide that involves repeated addition of pure water and decantation, hydrogen peroxide is added to obtain a yellow transparent aqueous solution of peroxo titanic acid. By subjecting this aqueous solution of peroxo titanic acid to a hydrothermal reaction under high pressure at a temperature of 80 to 250° C., an anatase type titanium dioxide dispersion can be obtained.

In the vinyl chloride-based resin composition of the present invention, either a single titanium dioxide may be used alone, or two or more titanium dioxides having different average particle diameters, crystal forms and/or properties may be used in combination.

The amount of the titanium dioxide used within the vinyl chloride-based resin composition of the present invention, reported as a mass ratio relative to the mass of the vinyl chloride-based resin, is typically within a range from 1,000 ppm to 10,000 ppm, preferably from 2,000 ppm to 8,000 ppm, and more preferably from 3,000 ppm to 5,000 ppm. If this amount is less than 1,000 ppm, then the thermal stability effect achieved by adding the titanium dioxide may not manifest satisfactorily. In contrast, an amount exceeding 10,000 ppm is not only undesirable from the viewpoints of resource conservation and cost reduction, but may also cause a deterioration in the post-molding external appearance of the resulting vinyl chloride-based resin composition.

### [Vinyl Chloride-based Resin]

The vinyl chloride-based resin used in the vinyl chloride-based resin composition of the present invention may be a homopolymer of a vinyl chloride monomer, a copolymer of a vinyl chloride monomer and another monomer that is copolymerizable with the vinyl chloride monomer, or a chlorinated product of an above-mentioned homopolymer or copolymer. In the copolymer, the amount of the vinyl chloride monomer is preferably at least 50% by mass of the mass of the whole monomer. The vinyl chloride-based resin is preferably obtained by suspension polymerization.

Examples of other monomers that are copolymerizable with the vinyl chloride monomer include vinyl esters such as vinyl acetate and vinyl propionate, alkyl acrylate esters such as methyl acrylate and ethyl acrylate, alkyl methacrylate esters such as methyl methacrylate and ethyl methacrylate, α-olefin monomers such as ethylene and propylene, as well as alkyl vinyl ethers, acrylic acid, methacrylic acid, acrylonitrile, styrene monomers and vinylidene chloride. These monomers that are copolymerizable with the vinyl chloride monomer may be used individually, or in combinations of two or more monomers.

The average polymerization degree of the vinyl chloride-based resin used in the vinyl chloride-based resin composition of the present invention is preferably within a range from 500 to 3,000, and more preferably from 700 to 1,300. Provided the average polymerization degree is within the range from 500 to 3,000, the melt viscosity of the resulting vinyl chloride-based resin composition does not become overly high, which facilitates the molding of the composition into a desired shape, and the resulting molded item is more likely to exhibit satisfactory shock resistance, making it easier to achieve the desired properties. In this specification, the average polymerization degree of the vinyl chloride-based resin is measured using the method prescribed in JIS K 7367-2.

### [Other Components]

Optional components other than the components described above may be added to the vinyl chloride-based resin composition of the present invention in accordance with the intended application of the composition. A single optional component may be used, or two or more different optional components may be used in combination.

Examples of these optional components include stabilizers. Conventional stabilizers may be used as stabilizers within the vinyl chloride-based resin composition of the present invention, including Sn-based stabilizers and Ca—Zn-based stabilizers. Ca—Zn-based stabilizers, which satisfy the demands for non-toxic, odorless, colorless and low-cost stabilizers, are preferred. The amount added of the stabilizer, and particularly a Ca—Zn-based stabilizer, is preferably within a range from 2 to 10 parts by mass per 100 parts by mass of the vinyl chloride-based resin. Provided this amount is within the range from 2 to 10 parts by mass, the resulting thermal stability effect tends to be satisfactory, the long-run properties during molding by extrusion or the like can be effectively improved, and resource conservation and cost reductions are more likely to be achieved.

Other optional components besides the stabilizers described above, including the various additives typically used within vinyl chloride-based resin compositions such as lubricants, colorants, dispersants, antioxidants, ultraviolet absorbers and flame retardants may also be added to the composition of the present invention.

### 2. Method of Producing Vinyl Chloride-based Polymer Composition

### [Addition of Titanium Dioxide]

The description relating to titanium dioxide within the above section entitled “1. Vinyl Chloride-based Resin Composition” also applies to the titanium dioxide used in the production method of the present invention, with the exception of the final paragraph of the above section (namely, the paragraph relating to the amount of the titanium dioxide).

In the production method of the present invention, the titanium dioxide described above may be added to the raw material prior to commencement of the polymerization, to the reaction mixture during the polymerization, to the reaction product following completion of the polymerization, or to a combination of two or more of the raw material, the reaction mixture and the reaction product. In those cases where the titanium dioxide is added to the reaction mixture during the polymerization, the addition period is preferably within the initial stages following commencement of the suspension polymerization. In those cases where the titanium dioxide is added to the reaction product following completion of the polymerization, examples of the method used for adding the titanium dioxide include adding the titanium dioxide to the polymer slurry that is recovered following completion of the polymerization, and adding the titanium dioxide to the cake obtained by dewatering the polymer slurry (the dewatered cake). Of the various possibilities, addition to the above-mentioned polymer slurry or the above-mentioned dewatered cake is preferred.

The amount of the titanium dioxide used in the production method of the present invention, reported as a mass ratio relative to the mass of the whole monomer, is typically within a range from 1,000 ppm to 10,000 ppm, preferably from 2,000 ppm to 8,000 ppm, and more preferably from 3,000 ppm to 5,000 ppm. Provided this amount is within the range from 1,000 ppm to 10,000 ppm, the thermal stability effect achieved by adding the titanium dioxide tends to manifest satisfactorily, resource conservation and cost reduction can be achieved more effectively, and molding of the resulting polymer composition is more likely to yield a molded item of favorable external appearance. In those cases where the suspension polymerization is conducted using only a vinyl chloride monomer, the expression “whole monomer” refers to the vinyl chloride monomer, whereas in those cases where the suspension polymerization is conducted using a monomer mixture containing a vinyl chloride monomer and at least one other monomer that is copolymerizable therewith, the expression “whole monomer” refers to the combined total of all the monomers within the monomer mixture.

### [Suspension Polymerization]

The suspension polymerization can be started, for example, by charging a polymerization vessel with the raw materials, such as the vinyl chloride-based monomer, the aqueous medium, a dispersion assistant, and any other additives that may be added according to need, subsequently adding a polymerization initiator, and then passing hot water through the jacket to raise the temperature inside the polymerization vessel to a predetermined polymerization reaction temperature. Subsequently, the reaction is allowed to proceed with the reaction mixture inside the polymerization vessel maintained at a predetermined reaction temperature, while the polymerization reaction heat is removed by using a cooling device such as a reflux condenser. The reaction temperature is preferably within a range from 20 to 80° C., and is more preferably from 35 to 70° C.

The vinyl chloride-based monomer used in the production method of the present invention is either a vinyl chloride monomer or a mixture of a vinyl chloride monomer and a monomer that is copolymerizable therewith. The mixture preferably contains a vinyl chloride monomer as the main component, and is more preferably a mixture comprising at least 50% by mass of the vinyl chloride monomer, together with the above-mentioned monomer that is copolymerizable therewith. Examples of the other monomer that is copolymerizable with the vinyl chloride monomer include olefins such as ethylene, propylene and butene, vinyl esters such as vinyl acetate and vinyl propionate, unsaturated carboxylic acids such as acrylic acid, methacrylic acid and itaconic acid, and alkyl esters thereof, vinyl ethers such as methyl vinyl ether, ethyl vinyl ether and octyl vinyl ether, as well as maleic acid and fumaric acid or anhydrides or esters thereof, and aromatic vinyl compounds. These monomers that are copolymerizable with the vinyl chloride monomer may be used individually, or in combinations of two or more monomers.

Examples of the dispersion assistant include water-soluble celluloses such as methyl cellulose, hydroxymethyl cellulose and hydroxypropyl methylcellulose, water-soluble partially-saponified polyvinyl alcohols, acrylic acid polymers, water-soluble polymers such as gelatin, oil-soluble emulsifiers such as sorbitan monolaurate, sorbitan trioleate, glyceryl stearate and ethylene oxide-propylene oxide block copolymers, and water-soluble emulsifiers such as polyoxyethylene sorbitan monolaurate, polyoxyethylene glyceryl oleate and sodium laurate. A single dispersion assistant may be used alone, or two or more dispersion assistants may be used in combination. The amount added of the dispersion assistant is preferably within a range from 0.02 to 1 part by mass per 100 parts by mass of the monomer.

There are no particular limitations on the polymerization initiator, and any of the initiators used in the production of conventional vinyl chloride-based polymers may be used. Specific examples of the polymerization initiator include peroxycarbonate compounds such as di(isopropyl)peroxydicarbonate, di(2-ethylhexyl)peroxydicarbonate and di(ethoxyethyl) peroxydicarbonate, peroxy ester compounds such as t-butyl peroxypivalate, t-hexyl peroxypivalate, t-butyl peroxyneodecanoate and α-cumyl peroxyneodecanoate, peroxides such as acetylcyclohexylsulfonyl peroxide, 2,4,4-trimethylpentyl-2-oxyphenoxy acetate and 3,5,5-trimethylhexanoyl peroxide, azo compounds such as azobis-2,4-dimethylvaleronitrile and azobis(4-methoxy-2,4-dimethylvaleronitrile), as well as potassium persulfate, ammonium persulfate and hydrogen peroxide. These polymerization initiators may be used individually, or in combinations of two or more different initiators. The amount added of the polymerization initiator is preferably within a range from 0.01 to 0.2 parts by mass per 100 parts by mass of the monomer.

In the production method of the present invention, appropriate amounts of other additives typically used in the production of vinyl chloride-based polymers may be used as required, including polymerization degree regulators, chain transfer agents, gelation improvers and antistatic agents. Further, antioxidants may be added to the polymerization system prior to the commencement of polymerization, during the polymerization or following completion of the polymerization, for purposes such as controlling the polymerization reaction and preventing deterioration of the product polymer.

### 3. Vinyl Chloride-based Polymer Composition

The vinyl chloride-based polymer composition of the present invention is obtained using the production method of the present invention. This polymer composition comprises a vinyl chloride-based polymer obtained by suspension polymerization and a titanium dioxide having an average particle diameter of 5 to 50 nm, and exhibits excellent thermal stability.

The composition may also include a stabilizer if required. The stabilizer may be a conventionally used stabilizer such as a Sn-based stabilizer or a Ca—Zn-based stabilizer, and a Ca—Zn-based stabilizer, which satisfies the demands for a non-toxic, odorless, colorless and low-cost stabilizer, is preferred.

### EXAMPLES

The present invention is described in more detail below using a series of examples and comparative examples, although the present invention is in no way limited by the following examples. In the following examples, the various measurements were performed using the methods outlined below.

### A. Vinyl Chloride-based Resin Composition

### Measurement of Average Particle Diameter:

The average particle diameter (D₅₀) of the microparticles of titanium dioxide within the titanium dioxide dispersion was measured using a particle size distribution measurement apparatus (product name: Nanotrac particle size analyzer UPA-EX, manufactured by Nikkiso Co., Ltd.).

### Measurement of Average Polymerization Degree:

The average polymerization degree of the vinyl chloride resin was measured using the method prescribed in JIS K 7367-2.

### Static Thermal Stability Test:

The produced vinyl chloride resin composition was kneaded for 5 minutes at 170° C. using a 6-inch twin roll mill, and was then molded into a sheet with a thickness of 0.8 mm. The thus obtained sheet was placed inside a hot oven at 210° C., and the time taken for the sheet to turn black (the blackening time) was measured. This blackening time was recorded as the static thermal stability time. The results are shown in Table 1.

### Dynamic Thermal Stability Test:

A plastograph PLE331 (manufactured by Brabender GmbH & Co. KG) was used as the test apparatus. With the jacket temperature of the test apparatus set to 215° C. the test apparatus was charged with 70 g of the vinyl chloride resin composition, the composition was kneaded at 60 rpm, and the time at which the torque started to increase (the torque increase start time) was measured. Because the torque starts to increase when the vinyl chloride resin within the composition starts to degrade, the torque increase start time corresponds with the degradation start time. This torque increase start time was recorded as the dynamic thermal stability time. The results are shown in Table 1.

### Observation of External Appearance Following Molding:

Observation of the external appearance following the molding of the produced vinyl chloride resin composition was evaluated using a 20 mmφ extruder. Using extrusion conditions including a screw with a compression ratio of 2.0, one 120-mesh screen and one 80-mesh screen and a T-die, and temperature conditions including C1: 150° C., C2: 180° C., C3: 170° C. and adapter: 190° C., a film of thickness 0.1 mm was extruded, and the external appearance of the thus obtained film was evaluated visually against the following criteria. The results are shown in Table 1.

+ a state in which the film surface was smooth and attractive

− a state in which the film surface was slightly rough

−− a state in which the film surface was rough

### Example 1

To 1,500 g of a vinyl chloride resin (average polymerization degree: 1,300) was added 625 g of a titanium dioxide dispersion (2.4% by mass, TO Sol manufactured by Kon Corporation, average particle diameter of titanium dioxide microparticles: 20 nm, dispersion medium: water), and the resulting mixture was stirred and mixed for 30 minutes using a Shinagawa mixer (manufactured by Kodaira Seisakusho Co., Ltd.). Following completion of the mixing, the resulting mixture was dried for 24 hours in an oven set at 40° C.

Following completion of the drying process, 1,010 g of the mixture, 25 g of a Ca—Zn-based stabilizer (FD-30S, manufactured by Akishima Chemical Industries Co., Ltd.) and 150 g of an epoxidized soybean oil (manufactured by Adeka Corporation) were combined in a 10 L mixer. The mixture was stirred at 1,800 rpm, and when the resin temperature reached 80° C., 300 g of diisononyl adipate was added. Stirring was then continued, and when the resin temperature reached 120° C., the mixture was removed from the mixer, yielding a vinyl chloride resin composition.

### Example 2

With the exceptions of altering the 625 g of the titanium dioxide dispersion used in Example 1 to 312.5 g, and altering the amount of the mixture added to the 10 L mixer from 1,010 g to 1.005 g, a vinyl chloride resin composition was prepared in the same manner as Example 1.

### Example 3

With the exceptions of altering the 625 g of the titanium dioxide dispersion used in Example 1 to 187.5 g, and altering the amount of the mixture added to the 10 L mixer from 1,010 g to 1,003 g, a vinyl chloride resin composition was prepared in the same manner as Example 1.

### Example 4

With the exceptions of replacing the 625 g of the titanium dioxide dispersion used in Example 1 with 49.7 g of a different titanium dioxide dispersion (15.1% by mass, SRD02-W manufactured by Sakai Chemical Industry Co., Ltd., average particle diameter of titanium dioxide microparticles: 8.6 nm, dispersion medium: water), and altering the amount of the mixture added to the 10 L mixer from 1,010 g to 1,005 g, a vinyl chloride resin composition was prepared in the same manner as Example 1.

### Comparative Example 1

With the exception of not adding the titanium dioxide, a vinyl chloride resin composition was prepared in the same manner as Example 1.

### Comparative Example 2

With the exceptions of altering the 625 g of the titanium dioxide dispersion used in Example 1 to 62.5 g, and altering the amount of the mixture added to the 10 L mixer from 1,010 g to 1,003 g, a vinyl chloride resin composition was prepared in the same manner as Example 1.

### Comparative Example 3

A 10 L mixer was charged with 1,000 g of a vinyl chloride resin (average polymerization degree: 1,300), 5 g of a titanium dioxide (JR-701 manufactured by Tayca Corporation, average particle diameter: 270 nm), 25 g of a Ca—Zn-based stabilizer (FD-30S manufactured by Akishima Chemical Industries Co., Ltd.) and 150 g of an epoxidized soybean oil (manufactured by Adeka Corporation). Subsequent operations were performed in the same manner as Example 1, yielding a vinyl chloride resin composition.

### Comparative Example 4

With the exceptions of altering the 625 g of the titanium dioxide dispersion used in Example 1 to 1,250 g, altering the drying time within the oven from 24 hours to 48 hours, and altering the amount of the mixture added to the 10 L mixer from 1,010 g to 1,020 g, a vinyl chloride resin composition was prepared in the same manner as Example 1.

TABLE 1

| | Example | | | | Comparative Example | | | |
|---|---|---|---|---|---|---|---|---|
| | 1 | 2 | 3 | 4 | 1 | 2 | 3 | 4 |
| Amount of added titanium | 10,000 | 5,000 | 3,000 | 5,000 | 0 | 100 | 5,000 | 20,000 |
| dioxide (ppm) | | | | | | | | |
| Average particle diameter | 20 | | | 8.6 | — | 20 | 200 | 20 |
| (nm) | | | | | | | | |
| Crystalline form | Anatase | | | Rutile | — | Anatase | Rutile | Anatase |
| Static thermal stability test: | 80 | 80 | 65 | 75 | 40 | 40 | 40 | 80 |
| Blackening time (minutes) | | | | | | | | |
| Dynamic thermal stability test: | 88.6 | 65.3 | 58.3 | 70.5 | 26.2 | 26.8 | 29.2 | 88.5 |
| Torque increase start time | | | | | | | | |
| (minutes) | | | | | | | | |
| External appearance following | + | + | + | + | + | + | − | − |
| molding | | | | | | | | |

B. Method of Producing Vinyl Chloride-based Polymer Composition, and Vinyl Chloride-based Polymer Composition Obtained using the Method Measurement of Average Particle Diameter:

Measured in the same manner as that described in the above section entitled “A. Vinyl Chloride-based Resin Composition”.

### Measurement of Polymerization Degree:

The polymerization degree of the vinyl chloride polymer was measured using the method prescribed in JIS K 7367-2.

### Static Thermal Stability Test:

To 100 parts by mass of the produced vinyl chloride polymer composition were added 2 parts by mass of a Ca—Zn-based stabilizer (FD-30S, manufactured by Akishima Chemical Industries Co., Ltd.), 15 parts by mass of an epoxidized soybean oil (manufactured by NOF Corporation) and 30 parts by mass of diisononyl adipate, and the resulting mixture was mixed uniformly using a Henschel mixer to obtain a compound. The thus obtained compound was kneaded for 5 minutes at 170° C. using a 6-inch twin roll mill, and was then molded into a sheet with a thickness of 0.8 mm. The thus obtained sheet was placed inside a hot oven at 210° C., and the time taken for the sheet to turn black (the blackening time) was measured. This blackening time was recorded as the static thermal stability time. The results are shown in Table 2.

### Dynamic Thermal Stability Test:

A compound was prepared in the same manner as that described for the static thermal stability test. A plastograph PLE331 (manufactured by Brabender GmbH & Co. KG) was used as the test apparatus. With the jacket temperature of the test apparatus set to 215° C., the test apparatus was charged with 70 g of the compound, the compound was kneaded at 60 rpm, and the time at which the torque started to increase (the torque increase start time) was measured. Because the torque starts to increase when the vinyl chloride polymer within the compound starts to degrade, the torque increase start time corresponds with the degradation start time. This torque increase start time was recorded as the dynamic thermal stability time. The results are shown in Table 2.

### Observation of External Appearance Following Molding:

A compound was obtained in the same manner as that described for the static thermal stability test. Observation of the external appearance following the molding of the compound was evaluated using a 20 mmφ extruder. Using extrusion conditions including a screw with a compression ratio of 2.0, one 120-mesh screen and one 80-mesh screen and a T-die, and temperature conditions including C1: 150° C., C2: 180° C., C3: 170° C. and adapter: 190° C., a film of thickness 0.1 mm was extruded, and the external appearance of the thus obtained film was evaluated visually against the following criteria. The results are shown in Table 2.

+ a state in which the film surface was smooth and attractive

− a state in which the film surface was slightly rough

−− a state in which the film surface was rough

### Example 5

A stainless steel polymerization vessel of internal capacity 100 liters fitted with a flat baffle stirrer and a jacket was charged with an aqueous solution prepared by dissolving 24 g of a partially saponified polyvinyl alcohol in 38 kg of deionized water. 10 kg of a titanium dioxide dispersion (2.4% by mass, TO Sol manufactured by Kon Corporation, average particle diameter of titanium dioxide microparticles: 20 nm, dispersion medium: water) was then added to the polymerization vessel. The inside of the polymerization vessel was then evacuated down to a pressure of 50 mmI Ig, and 24 kg of a vinyl chloride monomer was added to the vessel.

Subsequently, with the mixture inside the polymerization vessel undergoing constant stirring, 14.4 g of di(2-ethylhexyl)peroxydicarbonate was injected into the vessel by pump as a polymerization initiator. At the same time as this injection, an increase in the temperature was started, thereby initiating the polymerization. During the polymerization, the polymerization temperature was maintained at 52.5° C., and when the pressure inside the polymerization vessel reached 0.65 MPa, the polymerization was halted.

Following completion of the polymerization, the unreacted monomer was recovered from the polymerization vessel, and the polymer slurry was then recovered. The recovered polymer slurry was dewatered to obtain a cake. This cake was then dried in a drier until the water content decreased to not more than 0.5% by mass, thus yielding a vinyl chloride polymer composition. The polymerization degree of the vinyl chloride polymer within the thus obtained composition was 1.280.

### Example 6

A stainless steel polymerization vessel of internal capacity 100 liters fitted with a flat baffle stirrer and a jacket was charged with an aqueous solution prepared by dissolving 24 g of a partially saponified polyvinyl alcohol in 48 kg of deionized water. The inside of the polymerization vessel was then evacuated down to a pressure of 50 mmHg, and 24 kg of a vinyl chloride monomer was added to the vessel.

Subsequently, with the mixture inside the polymerization vessel undergoing constant stirring, 14.4 g of di(2-ethylhexyl)peroxydicarbonate was injected into the vessel by pump as a polymerization initiator. At the same time as this injection, an increase in the temperature was started, thereby initiating the polymerization. During the polymerization, the polymerization temperature was maintained at 52.5° C., and when the pressure inside the polymerization vessel reached 0.65 MPa, the polymerization was halted.

Following completion of the polymerization, the unreacted monomer was recovered from the polymerization vessel, and the polymer slurry was then recovered. 5 kg of the same titanium dioxide dispersion as that used in Example 5 was added to the recovered polymer slurry, and the resulting mixture was stirred for 30 minutes. Subsequently, the polymer slurry was dewatered to obtain a cake. This cake was then dried in a drier until the water content decreased to not more than 0.5% by mass, thus yielding a vinyl chloride polymer composition. The polymerization degree of the vinyl chloride polymer within the thus obtained composition was 1,280.

### Example 7

Operations up to and including the recovery of the polymer slurry were performed in the same manner as Example 6. The recovered polymer slurry was then dewatered to obtain a cake. 3 kg of the same titanium dioxide dispersion as that used in Example 5 was added to, and mixed with, the cake. This cake containing the titanium dioxide was then dried in a drier until the water content decreased to not more than 0.5% by mass, thus yielding a vinyl chloride polymer composition. The polymerization degree of the vinyl chloride polymer within the thus obtained composition was 1.280.

### Example 8

Using the same procedure as Example 6, but with the exception of not adding the 5 kg of the same titanium dioxide dispersion as that used in Example 5 to the recovered polymer slurry, but rather adding 79.5 g of a different titanium dioxide dispersion (15.1% by mass, SRD02-W manufactured by Sakai Chemical Industry Co., Ltd., average particle diameter of titanium dioxide microparticles: 8.6 nm, dispersion medium: water) to the polymer slurry, a vinyl chloride polymer composition was prepared in the same manner as Example 6. The polymerization degree of the vinyl chloride polymer within the thus obtained composition was 1,280.

### Comparative Example 5

With the exceptions of altering the amount of deionized water added from 38 kg to 48 kg, and not adding the titanium dioxide dispersion, a vinyl chloride polymer composition was obtained in the same manner as Example 5. The polymerization degree of the vinyl chloride polymer within the thus obtained composition was 1,280.

### Comparative Example 6

With the exception of altering the amount added of the titanium dioxide dispersion from 5 kg to 100 g, a vinyl chloride polymer composition was obtained in the same manner as Example 6. The polymerization degree of the vinyl chloride polymer within the thus obtained composition was 1,280.

### Comparative Example 7

Using the same procedure as Example 6, but with the exception of not adding the 5 kg of the same titanium dioxide dispersion as that used in Example 5 to the recovered polymer slurry, but rather adding 120 g of a titanium dioxide (JR-701 manufactured by Tayca Corporation, average particle diameter: 270 nm) to the polymer slurry, a vinyl chloride polymer composition was prepared in the same manner as Example 6. The polymerization degree of the vinyl chloride polymer within the thus obtained composition was 1,280.

### Comparative Example 8

With the exceptions of altering the amount of deionized water added from 38 kg to 28 kg, and altering the amount added of the titanium dioxide dispersion from 10 kg to 20 kg, a vinyl chloride polymer composition was obtained in the same manner as Example 5. The polymerization degree of the vinyl chloride polymer within the thus obtained composition was 1,280.

TABLE 2

| | Example | | | | Comparative Example | | | |
|---|---|---|---|---|---|---|---|---|
| | 5 | 6 | 7 | 8 | 5 | 6 | 7 | 8 |
| Amount of added titanium | 10000 | 5000 | 3000 | 5000 | 0 | 100 | 5000 | 20000 |
| dioxide (ppm) | | | | | | | | |
| Average particle diameter | 20 | | | 8.6 | — | 20 | 200 | 20 |
| (nm) | | | | | | | | |
| Method of adding titanium | a | b | c | b | — | b | b | a |
| dioxide ^{(Note)} | | | | | | | | |
| Crystalline form | Anatase | | | Rutile | — | Anatase | Rutile | Anatase |
| Static thermal stability test: | | | | | | | | |
| Blackening time (minutes) | 80 | 80 | 70 | 75 | 40 | 40 | 40 | 80 |
| Dynamic thermal stability test: | | | | | | | | |
| Torque increase start time | 88.3 | 68.2 | 60.4 | 74.5 | 27.0 | 27.0 | 30.2 | 88.4 |
| (minutes) | | | | | | | | |
| External appearance following | + | + | + | + | + | + | − | − |
| molding | | | | | | | | |

(Note)
a: The titanium dioxide was added to the raw material mixture prior to commencement of the polymerization by adding the polymerization initiator and simultaneously raising the temperature.
b: The titanium dioxide was added to the polymer slurry recovered from the polymerization vessel following completion of the polymerization.
c: The titanium dioxide was added to the cake obtained by dewatering the polymer slurry recovered from the polymerization vessel following completion of the polymerization.

What is claimed is:

1. A vinyl chloride-based resin composition comprising:
a vinyl chloride-based resin, and
a titanium dioxide having an average particle diameter of 5 to 50 nm, in an amount of 1,000 ppm to 10,000 ppm, by mass, relative to a mass of the vinyl chloride-based resin.

2. The vinyl chloride-based resin composition according to claim 1, wherein a crystalline form of the titanium dioxide is anatase, rutile, or a combination thereof.

3. The vinyl chloride-based resin composition according to claim 1, wherein an average polymerization degree of the vinyl chloride-based resin is within a range from 500 to 3,000.

4. The vinyl chloride-based resin composition according to claim 1, further comprising a stabilizer.

5. A method of producing a vinyl chloride-based polymer composition, the method comprising:
subjecting a vinyl chloride monomer, or a mixture of a vinyl chloride monomer and a monomer that is copolymerizable therewith, to suspension polymerization within an aqueous medium, and also comprising:
adding a titanium dioxide having an average particle diameter of 5 to 50 nm to a raw material prior to commencement of the polymerization, to a reaction mixture during the polymerization, to a reaction product following completion of the polymerization, or to a combination of two or more of the raw material, the reaction mixture and the reaction product.

6. The method according to claim 5, wherein an amount of the titanium dioxide added is within a range from 1,000 ppm to 10,000 ppm, by mass, relative to a mass of the whole monomer.

7. The method according to claim 5, wherein a crystalline form of the titanium dioxide is anatase, rutile, or a combination thereof.

8. A vinyl chloride-based polymer composition obtained using the method defined in claim 5.

9. The vinyl chloride-based polymer composition according to claim 8, comprising a vinyl chloride-based polymer obtained by suspension polymerization, and a titanium dioxide having an average particle diameter of 5 to 50 nm.

10. The vinyl chloride-based polymer composition according to claim 9, further comprising a stabilizer.
